(19) United States
(12) Patent Application Publication
(10) Pub. No.: US 2016/0174523 A1
(43) Pub. Date: Jun. 23, 2016

(54) Animal Coat

(71) Applicant: Jane Neveu, Derry, NH (US)

(72) Inventor: Jane Neveu, Derry, NH (US)

(21) Appl. No.: 14/863,640

(22) Filed: Sep. 24, 2015

Related U.S. Application Data
(60) Provisional application No. 62/096,154, filed on Dec. 23, 2014.

(51) Int. Cl. A01K 13/00

(52) U.S. Cl. CPC A01K 13/006

(57) ABSTRACT

An animal coat for keeping an animal warm during periods of cold weather. The coat is constructed for use by a four-legged animal, such as a dog or horse, among others. The coat includes an elongated panel having a front end and a rear end. The front end includes a pair of flaps that are connected to create an opening through which an animal's head can be positioned. The elongated panel covers the animal's back and drapes along the sides of the animal. The rear end of the elongated panel includes a pair of leg straps thereon, wherein the leg straps are configured in a loop. In use, each of an animal's hind legs are inserted into one of the leg straps so that the rear of the elongated panel is secured onto the animal's body. The coat is of unitary construction and is removably securable to an animal.

### CROSS REFERENCE TO RELATED APPLICATION

This application claims the benefit of U.S. Provisional Application No. 62/096,154 filed on Dec. 23, 2014. The above identified patent application is herein incorporated by reference in its entirety to provide continuity of disclosure.

### BACKGROUND OF THE INVENTION

### Field of the Invention

The present invention relates to garments for animals. More specifically, the present invention provides an animal coat for four-legged animals comprising an elongated panel having a pair of flaps on a front end thereof, wherein the flaps are secured to one another to create an opening through which the animal's head can be positioned. The coat further includes a pair of leg straps on a rear end thereof, wherein each leg strap is configured in a loop and is configured to receive a hind leg of the animal therethrough.

Dogs, horses, and other animals often become cold during the fall and winter and may not want to spend time outdoors. This is particularly true for small animals and animals with short coats. However, it is important for animals to spend time outdoors so that they can exercise and stay in good health. Similarly, animals may not wish to spend time outside when it is raining so as to avoid getting wet. Thus, an animal coat for keeping the animal warm and dry is desired.

Devices have been disclosed in the prior art that relate to garments for dogs and other animals. These include devices that have been patented and published in patent application publications. These devices generally relate to coats for animals comprising a cover and one or more straps for securing the coat on the animal, such as U.S. Pat. No. 7,121,231, U.S. Pat. No. 6,584,939, U.S. Pat. No. 5,060,458, U.S. Published Patent Application Number 2006/0169221, and U.S. Pat. No. 6,223,696.

These prior art devices have several known drawbacks. The devices in the prior art provide animal coats having straps for securing the same on the animal. However, securing a strap around the chest or stomach of an animal can be difficult for the owner. Further, the straps extending across the animal's chest may be uncomfortable, causing the animal to attempt to remove the coat. Thus, the present invention provides an animal coat having a head opening and a pair of leg straps for securing the animal coat onto the animal without the use of straps extending across the animal's chest or stomach.

In light of the devices disclosed in the prior art, it is submitted that the present invention substantially diverges in design elements from the prior art and consequently it is clear that there is a need in the art for an improvement to existing animal coats. In this regard the instant invention substantially fulfills these needs.

### SUMMARY OF THE INVENTION

In view of the foregoing disadvantages inherent in the known types of animal coats now present in the prior art, the present invention provides a new animal coat wherein the same can be utilized for providing convenience for the user when providing an animal with a garment to keep the animal warm and dry.

It is therefore an object of the present invention to provide a new and improved animal coat comprising an elongated panel having a pair of flaps that are secured to one another to define a neck opening at a front end thereof and having a pair of leg straps on the rear end thereof.

It is another object of the present invention to provide an animal coat comprising an elongated panel adapted to cover the back and sides of an animal.

Another object of the present invention is to provide an animal coat comprising a pair of leg straps configured in loops and adapted to receive an animal's legs therethrough so as to secure the animal coat onto the animal.

Yet another object of the present invention is to provide an animal coat having a unitary construction.

Another object of the present invention is to provide an animal coat that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 there is shown a planar view of the animal coat.

FIG. 2 there is shown a perspective view of the animal coat as worn by a dog.

### DETAILED DESCRIPTION OF THE INVENTION

Reference is made herein to the attached drawings. Like reference numerals are used throughout the drawings to depict like or similar elements of the animal coat. For the purposes of presenting a brief and clear description of the present invention, the preferred embodiment will be discussed as used for covering an animal's body in order to keep the animal warm and dry. The figures are intended for representative purposes only and should not be considered to be limiting in any respect.

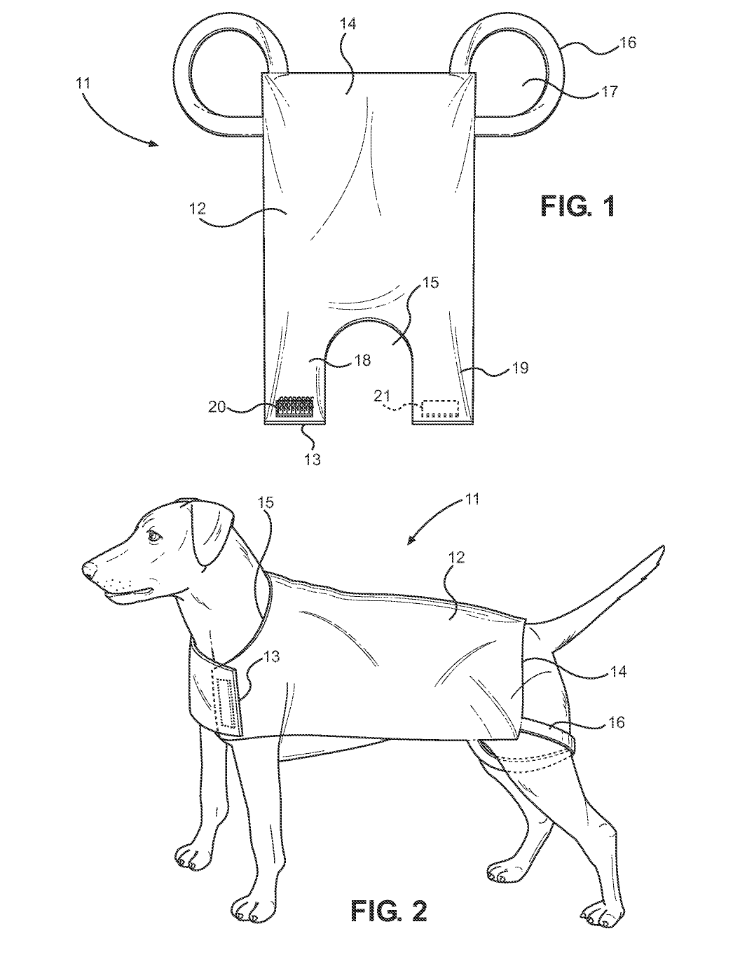

Referring now to FIG. 1, there is shown a planar view of the animal coat. The animal coat 11 comprises an elongated panel 12 having a front end 13 and a rear end 14. The elongated panel 12 is substantially rectangular in configuration. The elongated panel 12 is preferably composed of an insulating material so as to keep the animal warm during periods of cold weather. In some embodiments, the elongated panel 12 is composed of a waterproof material so that the animal coat 11 serves as a rain coat and helps to prevent the animal from becoming wet.

The elongated panel 12 comprises a pair of flaps 18, 19 on the front end 13 thereof, wherein the pair of flaps 18, 19 are separated by a head opening 15. The pair of flaps 18, 19 can be permanently secured to one another via stitching or the like, or can be removably secured together. In the illustrated embodiment, the pair of flaps 18, 19 includes fasteners 20, 21 thereon that can be removably secured together around the neck of the animal, so as to secure the animal coat 11 onto the animal. The fasteners 20, 21 may include any of various conventional fasteners, including but not limited to hook and loop fastening material, buttons, straps, or snaps, among others. When the fasteners 20, 21 are removably secured together, a head opening 15 is formed on the front end 13 thereof. The head opening 15 is sized so as to receive the head of an animal therethrough. The head opening 15 is shown as having a substantially circular configuration, however, in alternate embodiments the head opening 15 may have other shapes or configurations, such as a square shape, among others.

The rear end 14 of the animal coat 11 comprises a pair of leg straps 16 thereon. A first leg strap is positioned on a first side of the elongated panel 12 and a second leg strap is positioned on a second side of the elongated panel 12, wherein said second side is opposite said first side. The leg straps 16 extend outward from the rear end 14 of the elongated panel 12. Each leg strap 16 is configured in a loop so as to define a central opening 17. Each leg strap 16 is adapted to encircle one of an animal's hind legs so as to secure the animal coat 11 onto the animal's body. The leg straps 16 are shown as having a fixed construction, however, in alternate embodiments, the leg straps 16 are adjustable via one or more fasteners thereon, such as buckles, among other conventional adjustable fasteners.

Referring now to FIG. 2, there is shown a perspective view of the animal coat as worn by a dog. In operation, the animal's owner can secure the flaps around the animal's neck so that the animal's head extend through the head opening 15. The flaps on the front end 13 of the elongated panel 12 partially cover the front portion or chest of the animal. Further, the elongated panel 12 covers the animal's back and extends towards the animal's hind legs and tail. The elongated panel 12 drapes along the sides of the animal's body so as to cover the same. The elongated panel 12 leaves the animal's stomach or underbelly exposed so that the elongated panel 12 does not rub against the animal's stomach or interfere with the animal's ability to ambulate. Further, the animal coat 11 is unsecured to the animal's front legs so that the animal's front legs are not hindered by the animal coat 11.

The animal's hind legs are inserted into the leg straps 16 on the rear end 14 of the elongated panel 12. This helps to secure the animal coat 11 onto the animal's body so that the animal coat 11 does not shift position or fall off of the animal during use. Even if the animal rolls around, the animal coat 11 will remain secured on the animal's body. In some embodiments, the leg straps 16 each include adjustable fasteners thereon for allowing the user to tighten the leg strap 16 so that it fits more closely to the animal's hind legs.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An animal coat, comprising:
an elongated panel having a front end and a rear end;
a head opening on said front end through which an animal's head is adapted to be inserted;
a pair of leg straps secured to said rear end, wherein each leg strap is configured in a loop and is adapted to receive an animal's leg therethrough.

2) The animal coat of claim 1, wherein said elongated panel is substantially rectangular.

3) The animal coat of claim 1, wherein said head opening is defined by a pair of flaps extending from said elongated panel, wherein said pair of flaps are permanently secured to one another.

4) The animal coat of claim 1, wherein said head opening is defined by a pair of flaps extending from said elongated panel, wherein said pair of flaps are removably securable to one another.

5) The animal coat of claim 1, wherein said head opening comprises a substantially circular shape.

6) The animal coat of claim 1, wherein said pair of leg straps extend outward from said elongated panel.

7) The animal coat of claim 1, wherein said elongated panel is composed of an insulating material.

8) The animal coat of claim 1, wherein said elongated panel comprises a waterproof material.

9) The animal coat of claim 1, wherein said pair of leg straps comprise adjustable fasteners thereon.
